(19) United States
(12) Patent Application Publication
(10) Pub. No.: US 2004/0152031 A1
(43) Pub. Date: Aug. 5, 2004

(54) Disposable tongue plaque removing device

(76) Inventor: Atsushi Takahashi, Tsuruga (JP)

Correspondence Address: PITNEY, HARDIN, KIPP & SZUCH LLP, 685 Third Avenue, New York, NY, 10017, US

(21) Appl. No.: 10/358,867

(22) Filed: Feb. 5, 2003

(51) Int. Cl. A61D 5/00

(52) U.S. Cl. 433/1; 606/161

(57) ABSTRACT

A disposable tongue plaque removing device which prevents the user of the device from having a triggering effect of the user's vomiting reflex and to reduce incompatibility (negative sensation) to the user, but allows the user to remove tongue plaque from as far back of the oral cavity reaching the deepest part of the tongue.

### BACKGROUND OF THE INVENTION

This invention relates to a disposable tongue plaque removing device and to a disposable tongue plaque removing device which minimizes the on set of vomiting reflex, while allowing the user to effectively remove tongue plaque from the tongue surface.

Over 80% of bad breath in humans are said to be the result of tongue plaque found on the surface of the tongue and between the papillae of the tongue. There is a great need to remove the tongue plaque to avoid bad breath.

The tongue plaque removers of various shapes and sizes that utilize pressure from the user's hand and fingers to press the tongue plaque remover down onto the surface of the tongue are known. The tongue plaque remover pressed down onto the surface of the tongue is moved over the surface of the tongue. The tongue plaque remover scrapes the surface of the tongue and removes the tongue plaque. However, when the tongue plaque remover is pressed down onto the surface of the tongue by the pressure exerted by the user's hand and fingers, it is very easy for the user to experience the on set of the vomiting reflex.

The tongue is also known to contain very high concentration of nerve endings and is extremely sensitive to pressure exerted on the surface, making it susceptible for pain and irregular touch and taste sensation when exposed to excessive pressure. In addition, the known tongue plaque removers are designed to be used with the mouth open, causing the tongue to move upward and towards the roof of the oral cavity (palate), causing the user to experience the on set of the vomiting reflex. The known tongue plaque removers are also designed for repeated use, resulting in sanitary problems.

### SUMMARY OF THE INVENTION

Accordingly, it is an object of this invention to provide a tongue plaque removing device which removes tongue plaque efficiently from the entire tongue surface.

It is another object of the present invention to provide a tongue plaque removing device which removes tongue plaque efficiently from the entire tongue surface with the mouth closed.

It is still another object of the present invention to provide a tongue plaque removing device which removes tongue plaque efficiently from the entire tongue surface while eliminating the onset of the user's vomiting reflex.

It is still another object of the present invention to provide a tongue plaque removing device which removes tongue plaque efficiently from the entire tongue surface while reducing the negative sensation through reduction of pressure against the tongue by shaping the device to avoid exertion of excess pressure by the user's hand and fingers.

It is still another object of the present invention to provide a tongue plaque removing device which removes tongue plaque efficiently from the entire tongue surface while the device releases various flavors, anti-bacterial substances, herb extract, substances with aroma therapeutic effects, cavity preventing substances, substances with neutralizing effect against tongue plaque,

It is still another object of the present invention to provide a tongue plaque removing device which is made of paper material which is disposable.

It is still another object of the present invention to provide a tongue plaque removing device which the tongue plaque removing head located at one end of the device is shaped like a rake, shovel, loop, spoon, shell, or millipede.

It is still another object of the present invention to provide a tongue plaque removing device which the tongue plaque removing head located at one end of the device is made entirely or partly of candy.

It is still another object of the present invention to provide a tongue plaque removing device which consists of a tongue plaque removing head on one end and a pick on the other end of the device for cleaning inter-dental space.

It is still another object of the present invention to provide a tongue plaque removing device composed entirely or partially of candy-like material.

This invention allows the user to apply the tongue plaque remover to the tongue surface with the mouth closed and without directly exerting excessive pressure from the hand or fingers holding the device. This invention also allows cleaning and removal of the tongue plaque from all the way at the back of the tongue, including the edges and in between the papillae on the tongue surface, reduce vomiting reflection, and prevent pain and irregular taste or touching perception, and the increased handiness and disposability to make it more sanitary.

Just like how a new born child nurses, this invention can be used with the mouth closed to remove tongue plaque. The backside of the removing device is pressed against the palate by the upward pressure from the tongue. While the removing device is pressed against the palate by the tongue, the device is moved along the surface of the tongue to allow the tongue plaque collecting head to clean the tongue surface by removing and collecting the tongue plaque from the tongue surface and from spaces between the papillae. The tongue plaque device is used with the mouth closed and without the downward pressure exerted by the users hand.

The shape of the removing device where the device touches the tongue may be wave shaped, shaped with projections (protuberances) or with hairs, and is designed to reduce the stimulation to the tongue, preventing the onset of vomiting reflex, prevent painful sensation from the contact to the tongue, prevent irregular sensory perception and prevent irregular taste perception. The shape of the device is also designed to fit the contours of the oral cavity and the tongue so the device can be used with the mouth closed. The tongue plaque removing device may also be dipped, permeated or contain various flavors, anti-bacterial chemicals, aroma-therapeutic chemical, herb extracts, chemical with anti-cavity effect, or combination of one or more of the chemicals and materials.

The material used to construct the device is also made of material which is rigid enough to allow removal and collection of the tongue plaque but flexible enough to fit the contour of the tongue surface and the shape of the oral cavity to allow removal of the tongue plaque. By using injection mold paper and other disposable material, the device may be discarded after one use, avoiding unsanitary condition associated with repeated use of the removing device. The entire or part of the removing device may also be constructed from candy-like material.

### BRIEF DESCRIPTION OF THE DRAWINGS

FIG. 1 is a side view of a tongue plaque removing device according to a first embodiment of the present invention;

FIG. 2 is a side view of a tongue plaque removing device according to a second embodiment of the present invention;

FIG. 3 is a frontal view of a tongue plaque removing device according to the first embodiment of the present invention;

FIG. 4 is a back view of a tongue plaque removing device according to the first embodiment of the present invention;

FIG. 5 is side view of a tongue plaque removing device according to a third embodiment of the present invention;

FIG. 6 is a back view of a tongue plaque removing device according to the third embodiment of the present invention;

FIG. 7 is a cross sectional view of a part of a human head and oral cavity when using the tongue plaque removing device according to the third embodiment of the present invention;

FIG. 8 is a rear view of a tongue plaque removing device with the tongue plaque removing head composed entirely of candy according to a fourth embodiment of the present invention;

FIG. 9 is a “see-through” view of a section of a tongue plaque removing device composed entirely of candy which touches the tongue surface of the tongue according to the fourth embodiment of the present invention;

FIG. 10 is a front view of a tongue plaque removing device according to the fourth embodiment of the present invention;

FIG. 11 is a front “see-through” view of a tongue plaque removing device according to the fourth embodiment of the present invention;

FIG. 12 is a side view of a tongue plaque removing device according to the fourth embodiment of the present invention;

FIG. 13 is cross sectional view of a tongue plaque removing device of FIG. 10 and FIG. 11 along line A-A according to the fourth embodiment of the present invention;

FIG. 14 is a “see-through” view of a tongue plaque removing device wherein the tongue plaque collecting section is composed of candy and the tongue plaque collecting section is exposed according to the fourth embodiment of the present invention;

FIG. 15 is a front view of a tongue plaque removing device wherein the tongue plaque collecting section is composed of candy and the tongue plaque collecting section is exposed according to a fifth embodiment of the present invention;

FIG. 16 is a frontal “see-through” view of a tongue plaque removing device according to the fifth embodiment of the present invention;

FIG. 17 is a side view of a tongue plaque removing device according to the fifth embodiment of the present invention;

FIG. 18 is cross sectional view of a tongue plaque removing device of FIG. 12 and FIG. 16 along line C-C according to the fifth embodiment of the present invention; and

FIG. 19 is a view of a tongue plaque removing device's section which touches the surface of the tongue, which the tongue plaque collecting section is contained within the tongue plaque collecting section composed of candy according to a sixth embodiment of the present invention;

FIG. 20 is a frontal view of a tongue plaque removing device according to the sixth embodiment of the present invention;

FIG. 21 is a frontal “see-through” view of a tongue plaque removing device according to the sixth embodiment of the present invention;

FIG. 22 is a frontal cross sectional view of a tongue plaque removing device according to the sixth embodiment of the present invention;

FIG. 23 is a cross sectional view of the tongue plaque removing device according to the sixth embodiment of the present invention; and

FIG. 24 is a cross sectional view of the tongue plaque removing device of FIG. 20 and FIG. 21 along line D-D, according to the sixth embodiment of the present invention.

### DESCRIPTION OF PREFERRED EMBODIMENTS

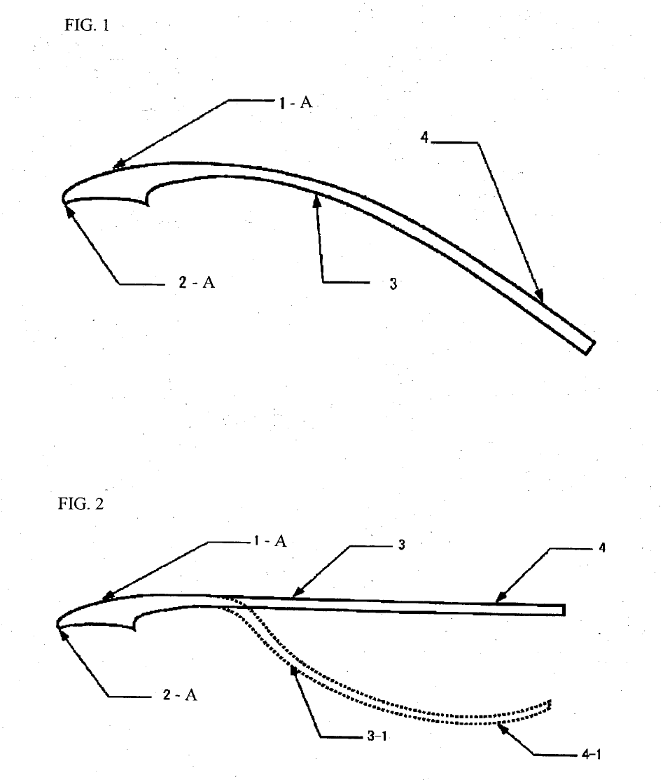

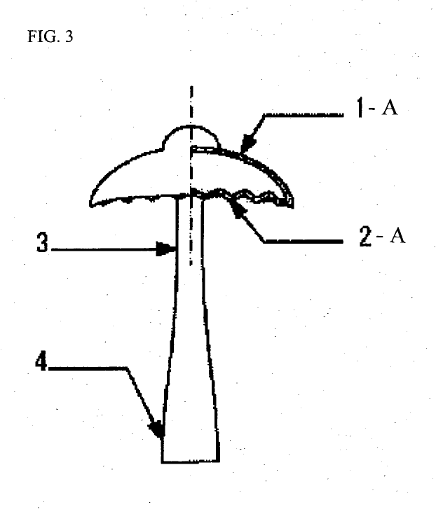

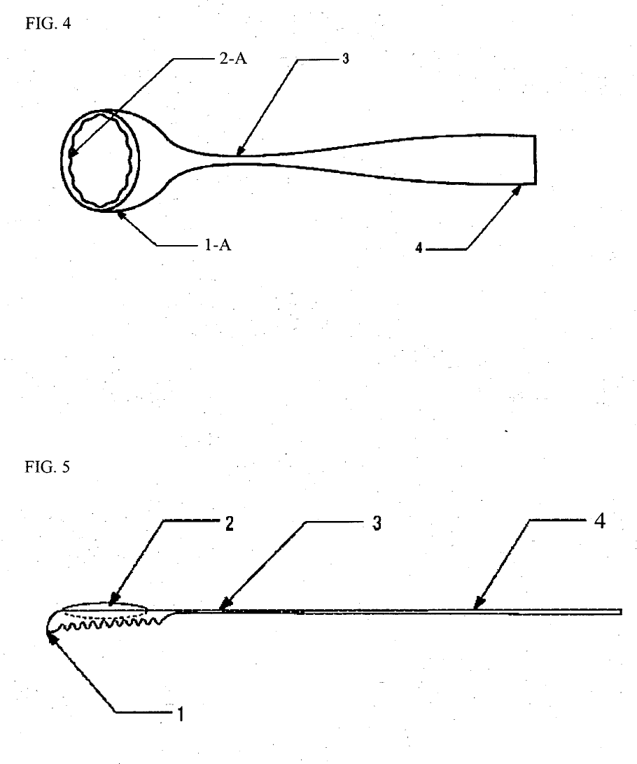

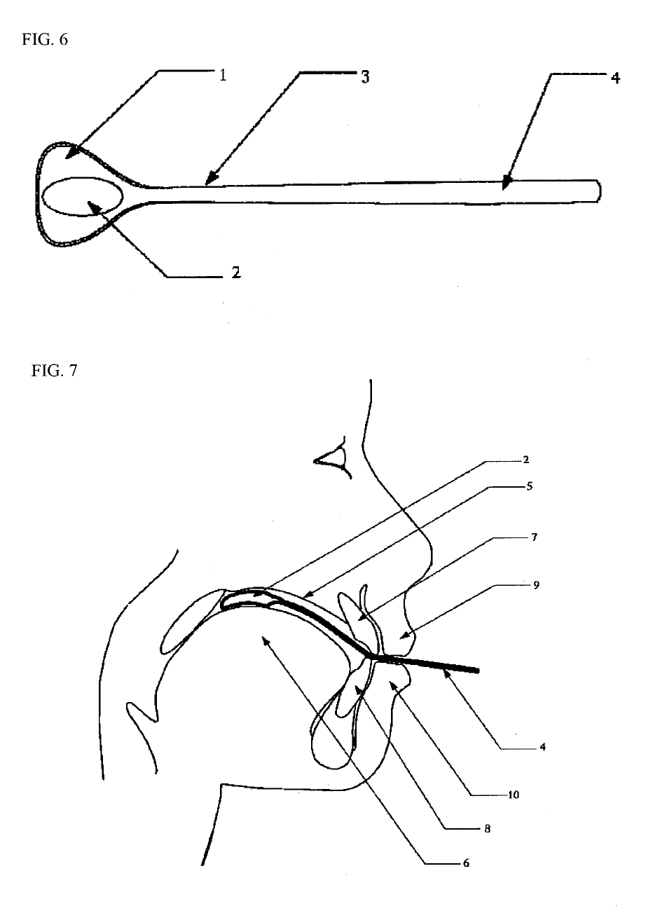

Referring to FIG. 1, a tongue plaque removing device according to a first embodiment is illustrated. The tongue plaque removing device as illustrated in FIG. 1 comprises a tongue plaque collecting head 1-A with a tongue plaque collection section 2-A at its one end, a neck section 3 and a handle section 4 at its other end.

The back side of a tongue plaque removing device's back side of the tongue plaque collecting head 1-A, the tongue plaque collecting section 2-A, the neck section 3, and the handle section 4 are shaped to fit the shape of the oral cavity and the tongue 6, enabling the user to use the device like sucking on a teething ring candy.

The tongue plaque removing device of FIG. 1 as a whole may be made of paper or plastic material which is free from environmental contamination problem and suitable as disposable.

According to the first embodiment, the invention allows the user to apply the tongue plaque removing device to the tongue surface with the mouth closed. Also exertion of excessive pressure from the hand or fingers holding the removing device is eliminated since the removing device is used by pushing the device up against the palate from the pressure exerted by the tongue itself. The only movement the hand and fingers exerts are the forward and backward thrust of the removing device to scrape the surface of the tongue. The invention allows removing plaque from the tongue all the way to the back (deep) of the tongue, including the edges and in between the papillae on the tongue surface, while preventing the onset of the user's vomiting reflex by designing and shaping the device to be used with the mouth closed. By allowing the tongue to control the amount of pressure it exerts on its surface by having the device pushed against the palate, the pain and irregular taste or touching perception associated with excessive pressure on the tongue surface are also eliminated.

Just like how a new born child nurses, the first embodiment of the invention is used with the mouth closed. The backside of the removing device is pressed against the palate by the upward pressure from the tongue. While the removing device is pressed against the palate by the tongue, the device is moved along the surface of the tongue to allow the tongue plaque collecting head to clean the tongue surface by removing and collecting the tongue plaque from the tongue surface and from spaces between the papillae.

The shape of the removing device where the device touches the tongue may be also be wave shaped and may contain projections or hair like protuberances. It is designed to reduce the stimulation to the tongue, prevent the onset of vomiting reflex, prevent painful sensation from the contact to the tongue, prevent irregular sensory perception and prevent irregular taste perception. The shape of the device is also designed to fit the contours of the oral cavity and the tongue.

Referring to FIG. 2, a tongue plaque removing device according to a second embodiment, the neck section 3, and the handle section 4, are constructed from material that is flexible to fit the contours and shape of the oral cavity and the tongue surface when pressure is exerted on the device's neck section 3-1 and to the device's handle section 4-1.

According to the second embodiment, the material used to construct the removing device is made of material which is rigid enough to allow removal and collection of the tongue plaque but flexible enough to fit the contour of the tongue surface and the shape of the oral cavity to allow efficient removal of the tongue plaque.

By using injection mold paper and/or soft resin material which is rigid enough to allow removal and collection of the tongue plaque but flexible enough to fit the contours of the tongue and the shape of the oral cavity, the removing device according to the second embodiment may be used with the mouth closed, by pushing the removing device from the pressure of the tongue pushing the removing device against the palate and without exerting excessive pressure from the hand or fingers of the user holding the device. The same advantages listed under the first embodiment are achieved. In addition, by using injection mold paper, soft resin or other disposable material, the device may be discarded after one use, avoiding unsanitary condition associated with repeated use of the removing device.

Referring to FIG. 5, a tongue plaque removing device according to a third embodiment, a tongue plaque removing device consists from a tongue plaque collecting head 1, the neck section 3, the handle section 4, and section 2 which is permeated, sprayed or covered with flavors, anti-bacterial chemicals, chemicals that neutralize compounds containing sulfur, herb extracts, substances with aroma-therapeutic effects or a combination of the substances.

Referring to FIG. 7, a tongue plaque removing device according to the third embodiment is used with the mouth closed, just like how a baby nurses on a nipple, the device is held in place between the upper lip 9 and lower lip 10 and upper tooth 7 and lower tooth 8, and stabilizing the lower jaw bone by the masticatory muscle, preventing the tongue 6 from moving up. The pressure exerted by the tongue 6 pushes the device's backside of the tongue plaque collecting head section 5 up against the palate 5, and the neck section 4 and the handle section 3 takes the shape of neck section 3-1 and handle section 4-1 as described in FIG. 2 when it is under pressure. By pushing the device up against the palate 5 by the tongue 6 eliminates the necessity of exerting pressure by hand to push the device onto the tongue 6 and eliminating the onset of the user's vomiting reflex as a result of pressure exerted on the tongue 6. The flavors, chemicals, and/or the substances on section 2 is released into the oral cavity and onto the surface of the tongue as the device is used.

The release of flavors, anti-bacterial chemicals, chemicals that neutralize compounds containing sulfur, herb extracts, substances with aroma-therapeutic effects or a combination of the substances decreases any negative sensation associated with removal of tongue plaque and also allow the user to benefit from the beneficial effects of the substances.

According to the third embodiment of the invention, the tongue plaque removing device constructed according to either the first embodiment or the second embodiment may be dipped in, permeated with or to have the material constructing the removing device to contain various flavors, anti-bacterial chemicals, aroma-therapeutic chemical, herb extracts, chemical with anti-cavity effect, or combination of one or more of the chemicals and materials.

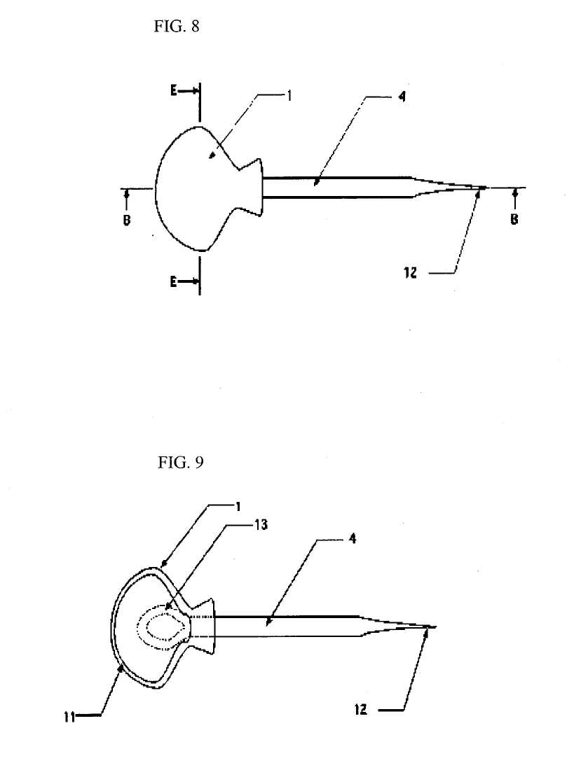

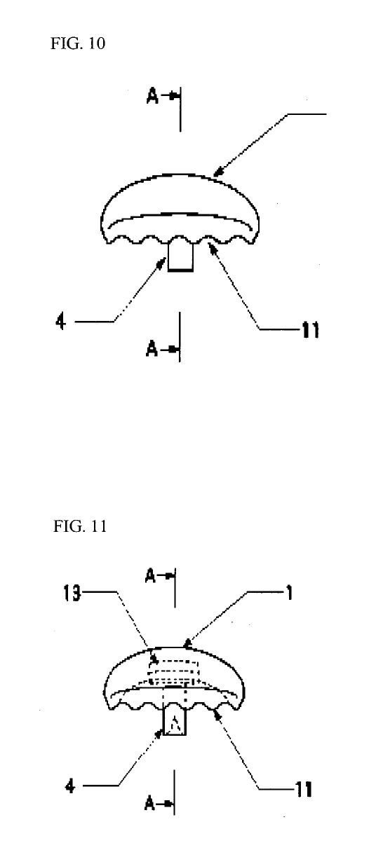

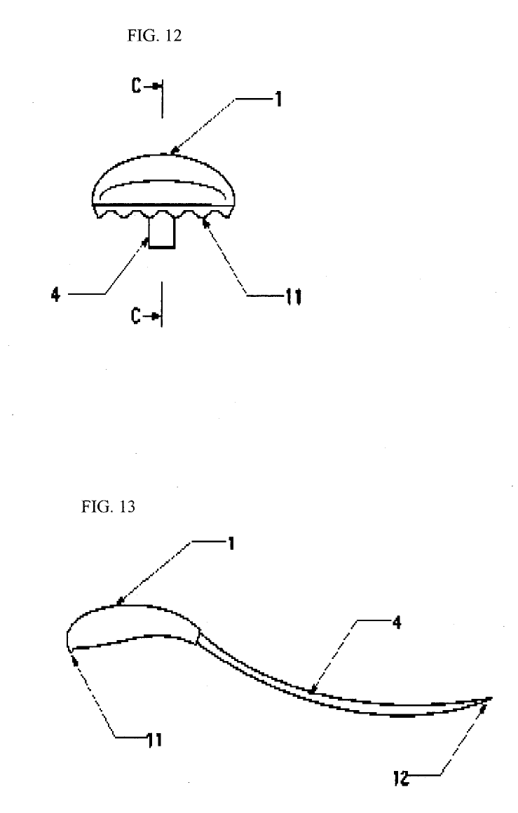

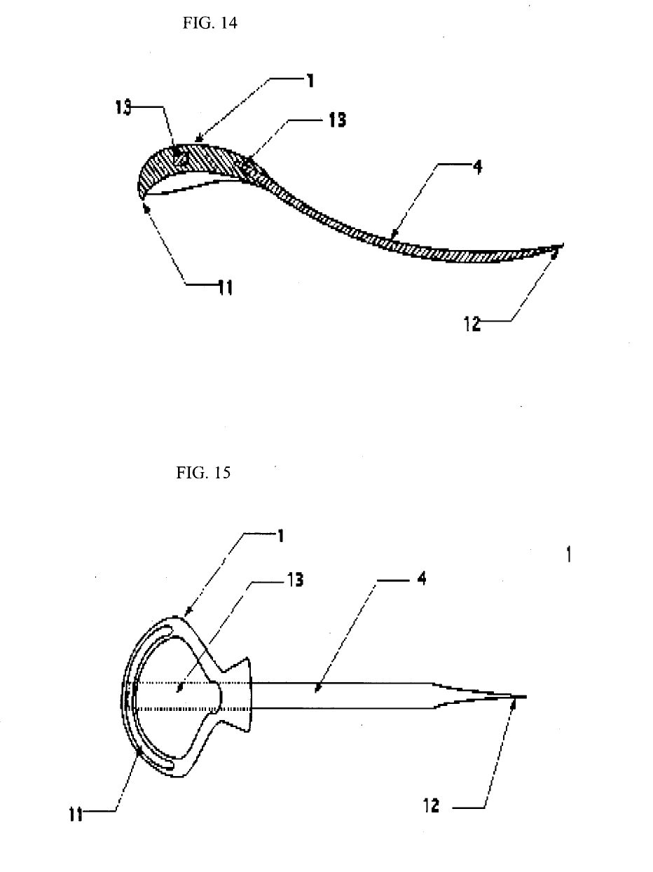

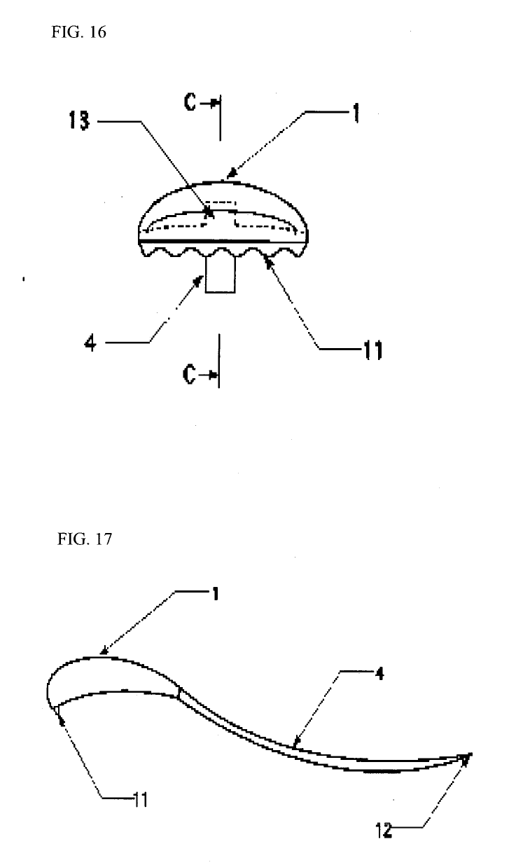

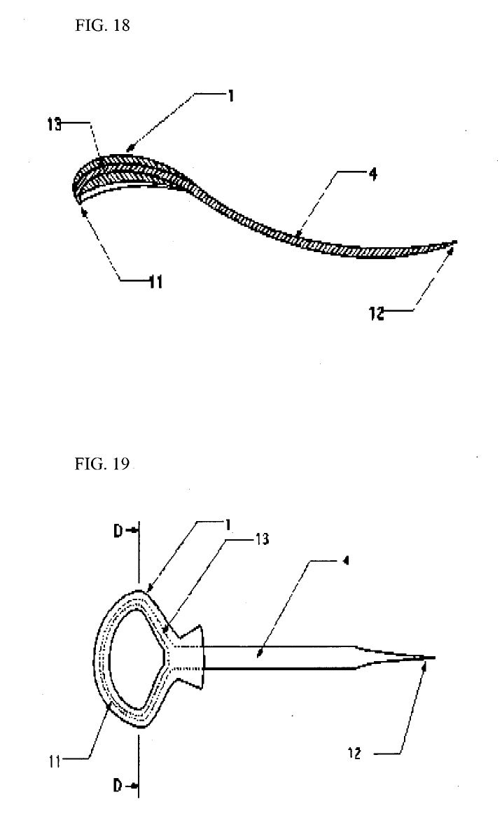

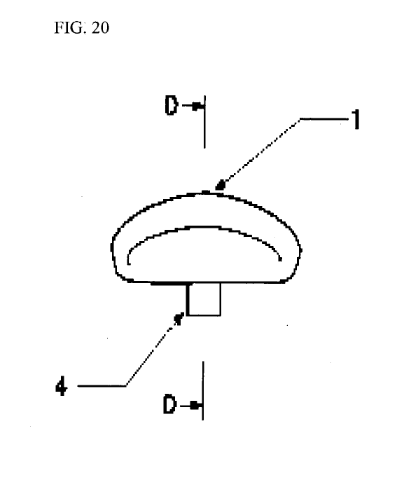

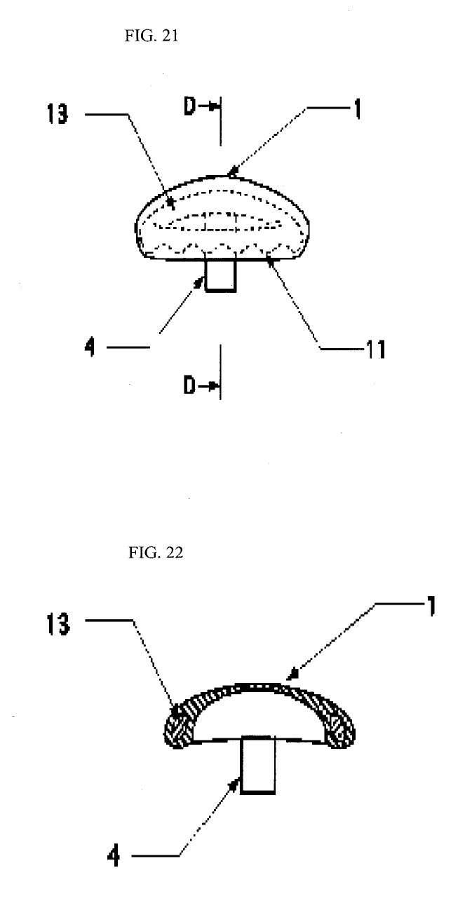

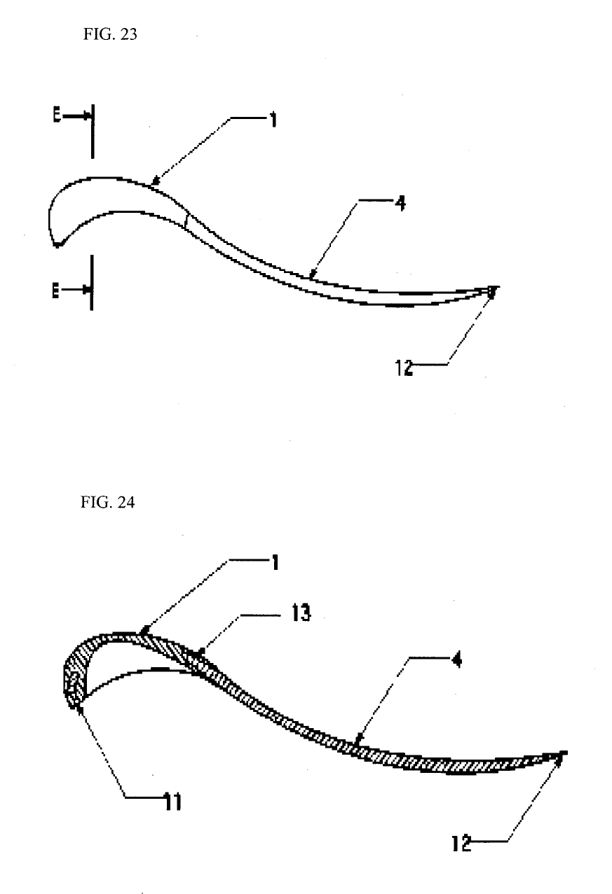

Referring to FIG. 8, a tongue plaque removing device according to a fourth embodiment, a tongue plaque removing device with a tongue plaque collecting head 1, the neck section 3, the handle section 4, and the pick section 12 used to clean interdental space, and the entire tongue plaque collecting head 1, is made from candy-like substance.

Referring to FIG. 9, a tongue plaque removing device according to a fourth embodiment, with the frame work 13 to hold the tongue plaque collecting head 1 made from candy-like substance.

Referring to FIG. 15, a tongue plaque removing device according to a fifth embodiment, with the tongue plaque collecting section 11, exposed from the tongue plaque collecting head 1 which is made from candy-like substance.

Referring to FIG. 19, a tongue plaque removing device according to a sixth embodiment, with the tongue plaque collecting section 11 contained with in the tongue plaque collecting head 1 made from candy-like substance.

According to the fourth, fifth, and sixth embodiment, an effect similar to the third embodiment is attained.

As described above, the tongue plaque removing device is made of paper material in the particular embodiment. It is more preferable that the device is made of paper material prepared by injection molding. This PIM material (paper by injection molding) is flexible enough to comply with the contour of the oral cavity. The following lists individual properties of the PIM materials as compared with the conventional materials.

| | PIM Material | | | | |
|---|---|---|---|---|---|
| | | Newspaper/ | | | |
| | Wood | recycled | General Purpose Resin | | Poly-lactic |
| | pulp | paper | PS Resin | PP Resin | Acid |
| Density | 0.85 | 0.78 | 1.05 | 0.90 | 1.25 |
| g/m2 | | | | | |
| Tensile | 290 | 190 | 270 | 190 | 690 |
| Strength | | | | | |
| Kgf/cm2 | | | | | |
| Stretch % | 8.5 | 4.8 | 40.0 | 80.0 | 4.0 |
| Bending | 245 | 350 | 470 | 330 | 1000 |
| Strength | | | | | |
| Kgf/cm2 | | | | | |
| Flectional | 2.9 × 10⁴ | 3.6 × 10⁴ | 2.5 × 10⁴ | 1.2 × 10⁴ | 3.8 × 10⁴ |
| elasticity | | | | | |
| Kgf/cm2 | | | | | |
| Impact | 11.5 | 5.6 | 6.0 | 6.6 | 2.1 |
| strength | | | | | |
| Kg · cm/ | | | | | |
| cm2 | | | | | |
| Half life | 2 | 2 | | | |
| of static | | | | | |
| electricity | | | | | |
| (seconds) | | | | | |

Therefore, while the description above provides a full and complete disclosure of the preferred embodiments of the present invention, various modifications, alternate constructions and equivalents may be employed without departing from the true scope and spirit of the invention.

What is claimed is:

1. A spoon shaped tongue plaque removing device comprising:
a head at one end for scraping and removing tongue plaque,
a handle at the other end for the user to hold the removing device, and
a neck for connecting between the head and the handle,
wherein the entire removing device is shaped or designed to fit the contours of the cross sectional shape of a part of a human head and the oral cavity to allow the user of the removing device to hold the removing device between the lips to be stabilized between the upper front tooth and lower front tooth, and allow the user to move the removing device along the upper surface of the tongue with the mouth closed and pressure from the tongue pushing the removing device upwards onto the palate of the oral cavity and thereby allow the user to remove tongue plaque from the surface of the tongue and clean the tongue while avoiding the vomiting reflex from inserting an object deep into the oral cavity.

2. A tongue plaque removing device as set forth in claim 1 wherein the head, the handle, and the neck are constructed from paper material or soft resin material to fit the contours of the cross sectional shape of the oral cavity, when pressure from the tongue is applied to the removing device and sandwiched between the tongue and the palate.

3. A tongue plaque removing device as set forth in 2, wherein the head has a tongue collection section shaped with waves or with protuberances, to reduce the irritation to the tongue and increase the efficiency of collecting and removing the tongue plaque by allowing the removing device to contact and collect/remove tongue plaque from the deepest part of the tongue.

4. A tongue plaque removing device as set forth in claim 3 wherein the surface of the plaque collecting section where the removing device touches the tongue or the tongue plaque collection head or the entire removing device, is covered, sprayed or permeated with flavors such as mint, raspberry, and other fruits.

5. A tongue plaque removing device as set forth in claim 4 wherein by wetting the tongue collecting section with water or with the user's saliva, such flavor is released into the oral cavity and from the movement to remove tongue plaque, the device is moved over the surface of the tongue, releasing and allowing the substance with the flavor to reach even the deepest part of the papillae, and improve the usage sensation by providing refreshing and cool taste like sensation.

6. A tongue plaque removing device as set forth in claim 3 wherein the surface of the plaque collecting section where the device touches the tongue or the tongue collection head or the entire removing device, is covered, sprayed or permeated with chemical or pharmaceutical with anti-bacterial effect, and by wetting the tongue collecting section with water or with the user's saliva, such flavor is released into the oral cavity and from the movements to remove tongue plaque, the device is moved over the surface of the tongue, releasing and allowing the aforementioned substance with the flavor to reach even the deepest part of the papillae, and improve the usage sensation by providing refreshing and cool taste like sensation.

7. A tongue plaque removing device as set forth in claim 1 wherein the surface of the plaque collecting section where the device touches the tongue or the tongue plaque collecting head or the entire removing device, is covered, sprayed or permeated with substance which contains fragrance like flavors of herb extract, and by wetting the tongue collecting section with water or with the user's saliva, the substance which contains the fragrance and/or flavor of the herb extract is released into the oral cavity, releasing a fragrance and/or flavor of the herb extract, and from the movements to remove tongue plaque, the device is moved over the surface of the tongue, which releases the fragrance of the substance through out the oral cavity with an aromatherapy like effect, and improve the usage sensation and also allow the release of fragrance when the user converses with another, the fragrance is released, improving the impression of the user.

8. A tongue plaque removing device as set forth in claim 1 wherein the surface of the plaque collecting section where the device touches the tongue, the tongue plaque collecting head or the entire removing device, is covered, sprayed or permeated with hydrogen sulfide, methyl captan, dimethyl sulfite and other substances which decompose or neutralize sulfur compounds, and by wetting the tongue collecting section with water or with the user's saliva, the substances such as hydrogen sulfide, methyl captan, dimethyl sulfite, and other substances which decompose or neutralize sulfur compounds are released into the oral cavity and from the movements to remove tongue plaque, the device is moved over the surface of the tongue, releasing and allowing the aforementioned substance(s) to reach even the deepest part of the papillae, and not only the device physically removes tongue plaque, but also through chemical reaction, improve the ability of removing bad breath.

9. A tongue plaque removing device as set forth in claim 1 wherein the tongue plaque removing section at one end with a shape suitable for removing tongue plaque, such as hoe shaped, millipede shaped, shovel shaped, loop shaped or shell shaped, and the tongue plaque removing section formed from candy with substance that provides a taste sensation of refreshing flavor or medicinal substance which controls the growth of bacteria or kills bacteria, or anti-cavity substance such as xylitol, or substance that contain fragrance capable of providing aromatherapy like effects, or substance through chemical reaction improve the ability of removing bad breath, mixed into the candy to allow the release of the substance into the oral cavity as it melts in the oral cavity from the contact with user's saliva, which is attached to a handle portion, which one end has a connecting section that buries into the aforementioned tongue removing section, and is formed from resin, wood, or paper.

10. A tongue plaque removing device described in claim 1 wherein the tongue plaque removing section on one end which is hoe shaped, millipede shaped, shovel shaped, loop shaped or shell shaped, and on the other end, a handle section formed from resin, wood, or paper, and the tongue plaque collection section partially or entirely covered by candy with substance that provides a taste sensation of refreshing flavor or medicinal substance which controls the growth of bacteria or kills bacteria, or anti-cavity substance such as xylitol, or substances that contain fragrance capable of providing aromatherapy like effects, or substance through chemical reaction improve the ability of removing bad breath, mixed into the candy to allow the release of the substance into the oral cavity as it melts in the oral cavity from the contact with user's saliva.

11. A tongue plaque removing device as set forth in claim 1 wherein one end of the device with the handle section forms a very sharp tooth pick shape, which allows the user to remove small pieces of food substance from the inter-dental spaces.

12. A tongue plaque removing device as set forth in claim 1 wherein the tongue plaque removing head and tongue plaque collecting section shaped or designed to have a concave shape to fit the contours of the surface of the tongue to allow removal and removing of tongue plaque from the side and from the upper surface of the tongue.

13. A tongue plaque removing device as set forth in claim 1 constructed from material which does not pollute the environment, such as paper material or other resin materials, and allowing the device to be disposable which prevents the unsanitary repeated use of the same device to remove tongue plaque.
